(19) United States
(12) Patent Application Publication
(10) Pub. No.: US 2026/0098402 A1
(43) Pub. Date: Apr. 9, 2026

(54) FOG INTERCEPTOR

(71) Applicant: Zurn Water, LLC, Milwaukee, WI (US)

(72) Inventors: Seth R. Wenzel, McKean, PA (US); Christopher J. Say, Waterford, PA (US)

(21) Appl. No.: 19/349,835

(22) Filed: Oct. 3, 2025

Related U.S. Application Data
(60) Provisional application No. 63/703,678, filed on Oct. 4, 2024.
(60) Provisional application No. 63/823,656, filed on Jun. 13, 2025.

(51) Int. Cl. E03F 5/16

(52) U.S. Cl. CPC E03F 5/16

(57) ABSTRACT

A FOG interceptor can be used to remove fats, oils, and grease and other waste particulates from wastewater before it enters a downstream wastewater system. A FOG interceptor includes a chamber, an inlet, an outlet, an inlet diffuser, and an outlet conduit. The chamber has at least one outer wall extending upward from a bottom wall. The inlet is located in an outer wall at a first end of the chamber. The outlet is located in an outer wall at the second end of the chamber. The inlet diffuser is fluidly coupled to the inlet and has a discharge opening in fluid communication with the chamber. The discharge opening has a first cross-sectional area that is at least four times a size of a first cross-sectional area of the inlet. The outlet conduit is fluidly coupled to the outlet and has an intake opening located in a lower region of the chamber.

### CROSS-REFERENCE TO RELATED APPLICATIONS

This application claims the benefit of co-pending U.S. Provisional Ser. No. 63/703,678, filed Oct. 4, 2024, and U.S. Provisional Ser. No. 63/823,656, filed Jun. 13, 2025, the entire contents of which are incorporated by reference herein.

### TECHNICAL FIELD

The present application relates to the treatment of wastewater products and, more particularly, to a fats, oils, and grease (FOG) interceptor designed for maximizing the disposal of grease, fats, and oils from wastewater.

### BACKGROUND

FOG interceptors are typically installed at locations where fats, oils, and grease (FOG) is likely to be conveyed down a drain system with wastewater. For example, FOG interceptors may be installed at restaurants and food processing facilities. During the cleaning process, FOG and other food particles may be washed away and deposited in the wastewater system if a FOG interceptor is not in place to mitigate the amount of contaminants that reach the wastewater system. FOG interceptors may be installed between the point of water disposal and the wastewater system to intercept and isolate FOG from fluid passing through the water disposal before the fluid continues downstream to the wastewater system.

### SUMMARY

In one independent aspect, a FOG interceptor for separating FOG from wastewater is provided. The FOG interceptor includes a chamber, an inlet, an outlet, an inlet diffuser fluidly coupled to the inlet, and an outlet conduit fluid coupled to the outlet. The chamber has at least one outer wall extending upward from a bottom wall. The inlet is located in the at least one outer wall at a first end of the chamber. The inlet has a first cross-sectional area. The outlet is located in the at least one outer wall at a second end of the chamber. The inlet diffuser has a discharge opening in fluid communication with the chamber, the discharge opening having a second cross-sectional area that is at least 2 times a size of the first cross-sectional area of the inlet. The outlet conduit has an intake opening located in a lower region of the chamber.

In some aspects, the inlet diffuser has a width that increases from a top of the inlet diffuser adjacent the inlet to a bottom of the inlet diffuser.

In some aspects, the inlet diffuser has a sidewall that is oriented at a first downward angle relative to a horizontal plane proximate a top of the inlet diffuser. The sidewall of the inlet diffuser is oriented at a second downward angle relative to the horizontal plane proximate a bottom of the inlet diffuser. The first downward angle is less than the second downward angle.

In some aspects, the inlet includes a flow control orifice for regulating flow of wastewater into the chamber.

In some aspects, the inlet includes a flow control orifice fitting having a flow control orifice. The flow control orifice fitting includes one of a key or a protrusion corresponding to the key, and the inlet diffuser includes the other of the key or the protrusion corresponding to the key for aligning orientation of the flow control orifice relative to an orientation of the inlet diffuser.

In some aspects, the FOG interceptor further includes a baffle that separates the chamber into a first sub-chamber and a second sub-chamber. A gap is provided between a bottom edge of the baffle and the bottom wall of the chamber such that wastewater can flow from the first sub-chamber to the second sub-chamber through the gap.

In some aspects, the baffle wraps around a vertical portion of the outlet conduit.

In some aspects, the FOG interceptor further includes a deflector extending upwards from the bottom wall, the deflector wrapping around the intake opening of the outlet conduit.

In some aspects, the FOG interceptor further includes a deflector extending across the bottom wall of the chamber, the deflector positioned between the first end and the second end of the chamber.

In some aspects, the FOG interceptor further includes an air bubbling device that injects air bubbles into the wastewater at the inlet.

In some aspects, the inlet diffuser has a vent in fluid communication with an upper region of the chamber.

In some aspects, the inlet diffuser includes a main body and a coupling portion, the coupling portion coupling the main body to the inlet. A first vent opening is disposed on the coupling portion, and a second vent opening is disposed on the main body of the inlet diffuser, the second vent opening positioned above the first vent opening.

In some aspects, the intake opening of the outlet conduit has a smaller cross-sectional area than the outlet.

In some aspects, a reducer is coupled to the outlet conduit to form the intake opening of the outlet conduit, the intake opening having a smaller cross-sectional area than a main body portion of the outlet conduit.

In another independent aspect, a FOG interceptor for separating FOG from wastewater is provided. The FOG interceptor includes a chamber, an inlet, an outlet, an inlet conduit fluidly coupled to the inlet, an outlet conduit fluid coupled to the outlet, and an air relief bypass. The chamber has at least one outer wall extending upward from a bottom wall. The inlet is located in the at least one outer wall at a first end of the chamber. The outlet is located in the at least one outer wall at a second end of the chamber. The inlet conduit has a discharge opening located in a lower region of the chamber. The outlet conduit has an intake opening located in a lower region of the chamber. The air relief bypass has a first aperture positioned proximate an upper end of the chamber and a second aperture positioned within the outlet conduit and below the outlet.

In some aspects, the air relief bypass is configured to simulate a vacuum pressure in the outlet conduit to maintain a wastewater level in the chamber above a lowermost portion of the outlet.

In some aspects, the air relief bypass is a bypass conduit extending through an upper end of the outlet conduit.

In some aspects, the FOG interceptor further includes a baffle that separates the chamber into a first sub-chamber and a second sub-chamber. A gap is provided between a bottom edge of the baffle and the bottom wall of the chamber such that wastewater can flow from the first sub-chamber to the second sub-chamber through the gap.

In some aspects, the baffle wraps around a vertical portion of the outlet conduit.

In some aspects, the FOG interceptor further includes a deflector extending upwards from the bottom wall, the deflector wrapping around the intake opening of the outlet conduit.

In another independent aspect, a FOG interceptor for separating FOG from wastewater is provided. The FOG interceptor includes a chamber, an inlet, an outlet, an inlet conduit fluidly coupled to the inlet, an outlet conduit fluid coupled to the outlet, and a flow control orifice. The chamber has at least one outer wall extending upward from a bottom wall.

The inlet is located in the at least one outer wall at a first end of the chamber. The outlet is located in the at least one outer wall at a second end of the chamber. The inlet conduit has a discharge opening located in a lower region of the chamber. The outlet conduit has an intake opening located in a lower region of the chamber. The flow control orifice fitting has a flow control orifice. The flow control orifice fitting includes one of a key or a protrusion corresponding to the key, and the inlet conduit includes the other of the key or the protrusion corresponding to the key for aligning orientation of the flow control orifice relative to an orientation of the inlet conduit.

In another independent aspect, a FOG interceptor for separating FOG from wastewater is provided. The FOG interceptor includes a chamber, an inlet, an outlet, an inlet conduit fluidly coupled to the inlet, an outlet conduit fluid coupled to the outlet, and a baffle. The chamber has at least one outer wall extending upward from a bottom wall. The inlet is located in the at least one outer wall at a first end of the chamber. The outlet is located in the at least one outer wall at a second end of the chamber. The inlet conduit has a discharge opening located in a lower region of the chamber. The outlet conduit has an intake opening located in a lower region of the chamber. The baffle wraps around a vertical portion of the outlet conduit. The baffle separates the chamber into a first sub-chamber at an exterior of the baffle and a second sub-chamber in an interior of the baffle.

In some aspects, a gap is provided between a bottom edge of the baffle and the bottom wall of the chamber such that wastewater can flow through the gap from the first sub-chamber to the second sub-chamber.

In some aspects, the FOG interceptor further includes a deflector extending upwards from the bottom wall, the deflector wrapping around the intake opening of the outlet conduit.

In another independent aspect, a FOG interceptor for separating FOG from wastewater is provided. The FOG interceptor includes a chamber, an inlet, an outlet, an inlet conduit fluidly coupled to the inlet, an outlet conduit fluid coupled to the outlet, and an air bubbling device. The chamber has at least one outer wall extending upward from a bottom wall. The inlet is located in the at least one outer wall at a first end of the chamber. The outlet is located in the at least one outer wall at a second end of the chamber. The inlet conduit has a discharge opening located in a lower region of the chamber. The outlet conduit has an intake opening located in a lower region of the chamber. The air bubbling device injects air bubbles into the wastewater in the inlet conduit. The air bubbling device includes an air intake located in an upper region of the chamber such that the air bubbling device recirculates air within the chamber.

In some aspects, an air discharge of the air bubbling device is positioned in an upper region of the inlet conduit and below a lowermost portion of the inlet.

Other aspects of the disclosure will become apparent by consideration of the detailed description and accompanying drawings.

### BRIEF DESCRIPTION OF THE DRAWINGS

FIG. 1 is a perspective view of a FOG interceptor according to one embodiment.

FIG. 2 is a perspective view of the FOG interceptor of FIG. 1 with a top access cover and other components removed.

FIG. 3 is a section view of a portion of the FOG interceptor of FIG. 1, viewed along section 3-3.

FIG. 4 is a partial section view of the FOG interceptor of FIG. 1, viewed along section 3-3.

FIG. 5 is a section view of a FOG interceptor according to another embodiment, viewed along a substantially longitudinal section line similar to section 3-3 shown in FIG. 1.

FIG. 6 is a perspective view of a FOG interceptor according to another embodiment.

FIG. 7 is a section view of the FOG interceptor of FIG. 6, viewed along section 7-7.

FIG. 8 is another section view of the FOG interceptor of FIG. 6, viewed along section 8-8.

FIG. 9 is a perspective view of a flow control orifice fitting for a FOG interceptor according to any of the prior embodiments.

FIG. 10 is a sectional perspective view of an inlet conduit for a FOG interceptor according to another embodiment.

FIG. 11 is a perspective view of a FOG interceptor according to another embodiment.

FIG. 12 is a section view of the FOG interceptor of FIG. 11, viewed along section 12-12.

FIG. 13 is a perspective view of a portion of the FOG interceptor of FIG. 11, with a top access cover and other components removed.

FIG. 14 is a perspective view of an inlet diffuser according to another embodiment.

FIG. 15 is a front view of the inlet diffuser of FIG. 14.

FIG. 16 is a section view of the inlet diffuser of FIG. 14, viewed along section 16-16.

FIG. 17 is a flow diagram of fluid in the inlet diffuser of FIG. 14.

FIG. 18 is a perspective view of an inlet diffuser according to another embodiment.

FIG. 19 is another perspective view of the inlet diffuser of FIG. 18.

### DETAILED DESCRIPTION

Before any embodiments are explained in detail, it is to be understood that the disclosure is not limited in its application to the details of the configuration and arrangement of components set forth in the following description or illustrated in the accompanying drawings. The disclosure is capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof, as well as possible additional items. Unless specified or limited otherwise, the terms “mounted,” “connected,” “supported,” and “coupled” and variations thereof are used broadly and encompass both direct and indirect mountings, connections, supports, and couplings.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4.” The relative terminology may refer to plus or minus a percentage (e.g., 1%, 5%, 10%, or more) of an indicated value.

A wastewater separation device, such as a FOG interceptor (also referred to as a grease interceptor), can be installed to remove fats, oil, and grease, solid waste, and other waste or particulates from wastewater (e.g., gray water) before entering a wastewater system such as a municipal sewage system (i.e., receive effluent from a wastewater or drainage system and discharge separated wastewater). A FOG interceptor can use the different densities or buoyancies of various contaminants to separate the FOG and contaminants from the water of the wastewater.

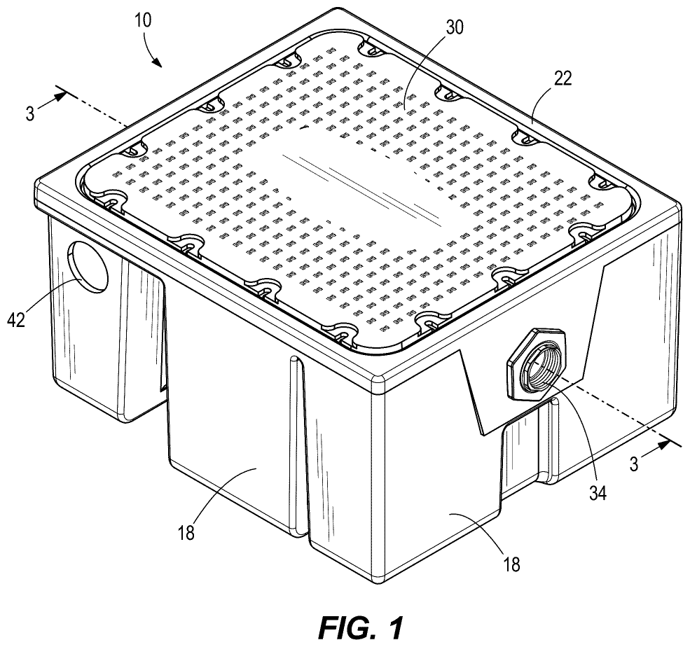

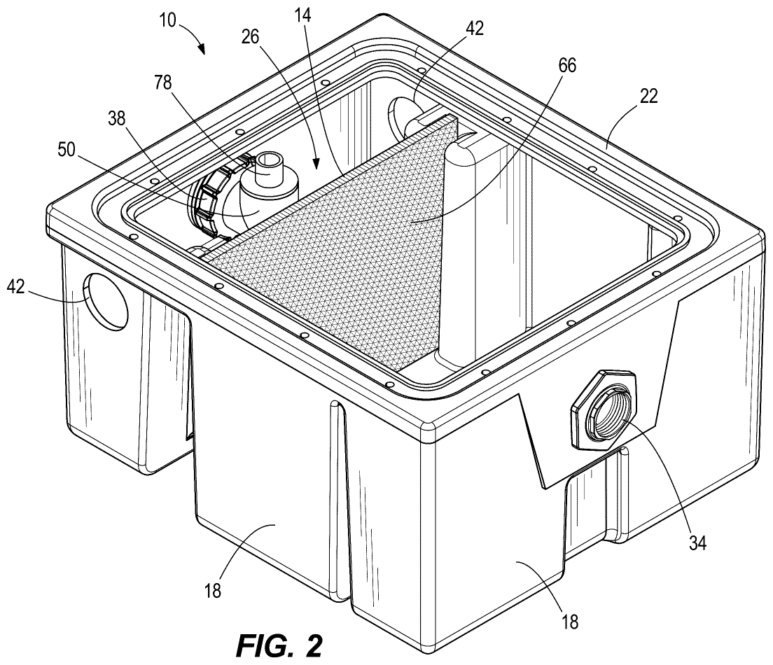

FIGS. 1 and 2 illustrate a separation device or FOG interceptor 10 including a lower wall (e.g., a bottom wall 14—FIG. 2), outer walls or sidewalls 18 extending upwardly therefrom, and an upper wall (e.g., a top wall 22). The bottom wall 14, side walls 18 and top wall 22 enclose a main chamber 26 of the interceptor 10. The top wall 22 may include an access cover 30, which can be removed (as shown in FIG. 2) for operator access to the chamber 26 and components therein. In the illustrated embodiment, the chamber 26 is enclosed by substantially planar surfaces and has a generally rectangular-prism or cuboid shape. In other embodiments, the chamber may have a different shape (e.g., cylindrical). The interceptor 10 can be sized to accommodate any suitable flow rate and/or FOG content of effluent to the interceptor 10. The interceptor 10 may be made from a plastic material, such as a polymer material, which can help resist corrosion. In some embodiments, alternative materials may be used, such as a metal or a hard rubber.

As best shown in FIG. 2, one end of the interceptor 10 may include an inlet 34 for coupling the interceptor to a wastewater or drainage system to receive water including FOG and other waste or particulates (i.e., effluent), and the opposite end of the interceptor 10 may include an outlet 38 for discharging the separated wastewater from the interceptor 10 to a downstream wastewater system. The interceptor 10 may include multiple outlet ports 42 such that the interceptor can be configured to have the outlet 38 discharge in an in-line configuration with the inlet 34 or in a left-hand or right-hand discharge configuration in relation to the inlet 34. The variable configurations of the inlet 34 and outlet 38 orientations can be useful for efficiently installing the interceptor 10 in various wastewater systems and floorplans. The outlet ports 42 that are not in use may be capped or plugged or may be connected to a FOG removal pump or system for removing the FOG and contaminants from the chamber 26 without an operator having to open or access the chamber 26. In some embodiments, the interceptor 10 may include multiple inlet ports in addition to or instead of multiple outlet ports 42.

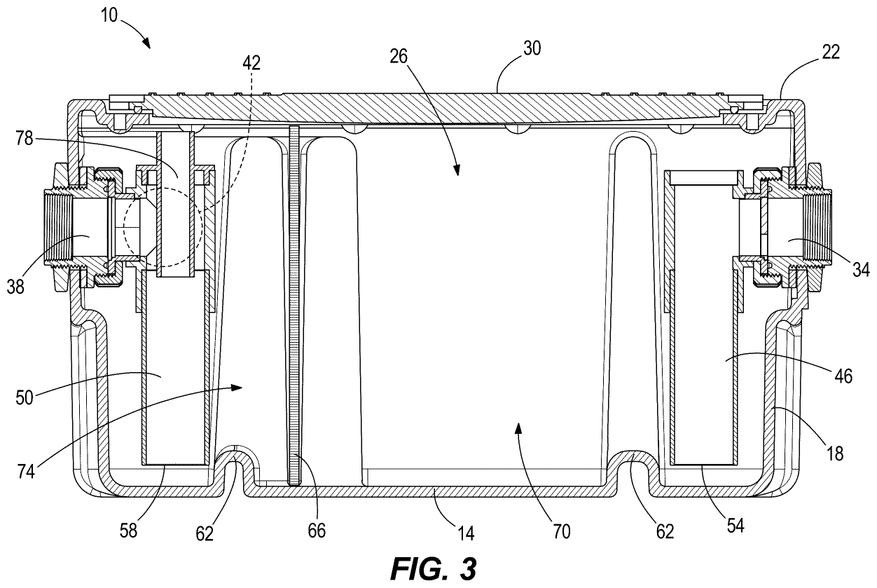

As shown in FIG. 3, effluent may enter the interceptor 10 through the inlet 34. The inlet 34 may be coupled to an inlet fitting or conduit 46 and the outlet 38 may be coupled to an outlet fitting or conduit 50. For example, as shown in FIG. 3, the inlet conduit 46 may be a tee, which can direct the incoming effluent to an inlet discharge 54 in a lower region of the chamber 26. Likewise, the outlet conduit 50 may be a tee that receives wastewater from an outlet intake 58 at a lower region and opposite end of the chamber 26 from the inlet discharge 54. Once in the chamber 26, the different densities or buoyancies of various contaminants in the effluent can separate the contaminants from the water. For example, FOG and other light density contaminants may rise to the top, while solid contaminants that are denser than water can sink to the bottom.

As shown in FIG. 3, the bottom wall 14 of the chamber 26 may include one or more risers or deflectors 62 that extend along a width of the chamber 26. These deflectors 62 can prevent solid debris and contaminants that have sunk to the bottom from flowing towards the outlet intake 58 where they could otherwise be entrained or sucked into the outlet conduit 50 as the wastewater velocity increases when entering the smaller area of the outlet conduit 50.

As shown in FIG. 3, the interceptor 10 may also include one or more baffles 66 extending between sidewalls 18 across the width of the chamber 26. The baffle 66 may extend to the top wall 22 (or at least substantially between the bottom wall 14 and the top wall 22) and may be spaced from the bottom wall 14 to allow wastewater to flow underneath the baffle 66 (i.e., flow through a gap between the baffle 66 and bottom wall 14) while preventing FOG that has floated upwardly from flowing past the baffle 66. As such, the baffle 66 can act as a divider to create multiple sub-chambers within the chamber 26. For example, as shown in FIG. 3, the baffle 66 can separate or partition an inlet chamber 70 from an outlet chamber 74. The baffle 66 may be positioned closer to the outlet 38 than the inlet 34 such that the inlet chamber 70 is larger and provides more time and space for FOG to separate from the wastewater and rise to the top before the wastewater flows under the baffle 66.

Increasing the overall size of the interceptor 10 can generally decrease the velocity of the wastewater and increase the retention time of the wastewater as it passes through the interceptor 10, both of which promote effective separation of FOG and contaminants from the wastewater. Interceptors 10 may need to be limited in size due to footprint or space constraints or for economic reasons such as cost of manufacturing. Therefore, it may be desirable to have an interceptor 10 with a greater effective liquid volume for a given footprint or physical volume of the interceptor 10.

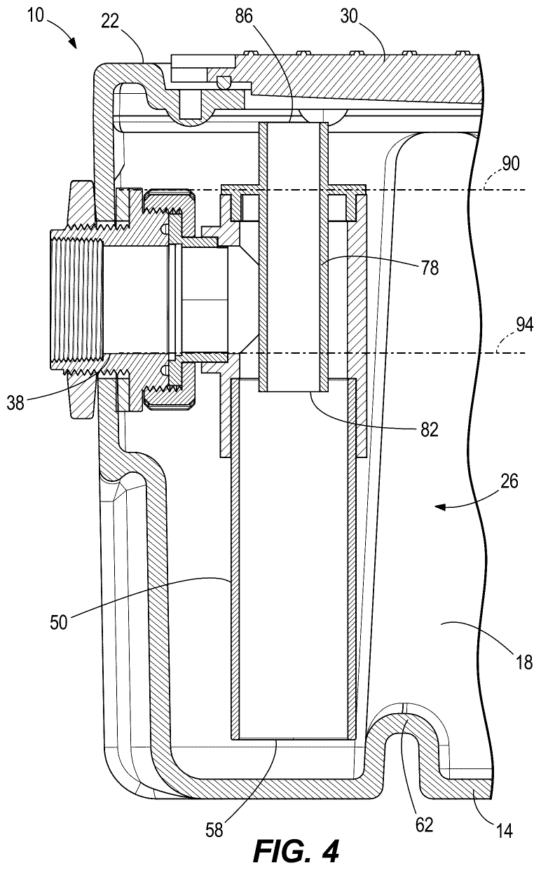

As best shown in FIG. 4, the outlet conduit 50 may include an air relief bypass 78, which can raise the effective liquid level in the chamber 26 during operation, thereby increasing the retention time of the wastewater. The air relief bypass 78 may be a conduit or tube within the outlet conduit 50 and may include a bottom opening 82 positioned below a bottommost portion of the outlet 38. The air relief bypass 78 may extend upwards through a top capped or sealed end of the outlet conduit 50 and include a top opening 86 positioned proximate to but below the top wall 22. During initial operation of the interceptor 10 (i.e., when effluent flows into the inlet 34), the chamber 26 experiences a pressure increase and the liquid level in the chamber 26 rises. Once operation stops (i.e., when effluent stops flowing into the inlet 34 or flows in at a low rate), the pressure inside the chamber 26 decreases and the liquid level begins to drop. However, the air relief bypass 78 provides a fluid pathway/connection between the small amount of air in a pocket at the top of the chamber 26 and the outlet conduit 50. Since the chamber 26 is sealed from the external atmosphere and no additional air is able to enter the chamber 26, the air pocket creates negative pressure that resists the liquid level dropping. Atmospheric pressure from the downstream wastewater pipe connected to the outlet 38 combines with the vacuum pressure transferred through the air relief bypass 78 to prevent the liquid level from dropping. The liquid level may be maintained at a pseudo-high level 90 (as indicated in FIG. 4) even while there is no active flow into the interceptor 10.

The pseudo-high level 90 of the liquid in the chamber 26 due to the sealed air relief bypass 78 can result in a greater effective liquid volume in the interceptor 10. The greater width-wise cross-section of liquid in the chamber 26 results in the effluent/wastewater moving at a slower speed from one end to the other of the chamber 26. The increased height of the liquid also can provide a greater vertical distance for the FOG and contaminants of the effluent to separate and stratify, which can result in a “cleaner” wastewater exiting the interceptor 10. Without the air relief bypass 78 and effective vacuum pressure it creates, the liquid level would be in the region of the bottommost portion of the outlet 38 as indicated by standard liquid level 94 (as shown in FIG. 4). The pseudo-high level 90 can be approximately 0.25 inches to five inches higher than the standard liquid level 94 and can result in a 10-60% increase in the liquid level and corresponding effective liquid volume in the chamber 26.

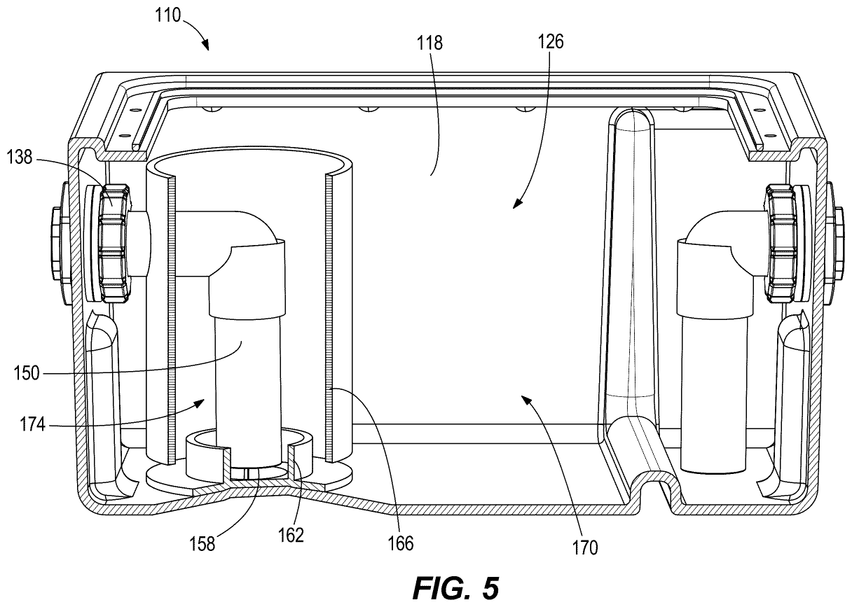

FIG. 5 illustrates another embodiment of an interceptor 110. Interceptor 110 may include a baffle 166 that wraps around the outlet conduit 150. As shown, the baffle 166 may have a cylinder shape. In some embodiments, the baffle 166 may have a rectangular, triangular, oval, or other cross-sectional geometry that surrounds the outlet conduit 150. Because the baffle 166 surrounds the outlet conduit 150, the baffle 166 provides a sealed outlet chamber 174 without having to be sealed to any sidewalls 118 of the interceptor 110. Forming a seal between the baffle 166 and the outlet conduit 150 can be easier and more repeatable than forming a seal between the baffle 166 and sidewall 118 or other portion of the chamber 126 due to the larger manufacturing tolerances of the chamber 126. The outlet conduit 150, which can be a standard plumbing fitting or pipe that is manufactured more consistently and with lower tolerances, can be more easily sealed to by the baffle 166. In addition, the circumference around the outlet conduit 150 requires a shorter seal length than the entire vertical height of the baffle 166 on each side in embodiments where the baffle 166 is sealed to sidewalls 118.

Using a baffle 166 that wraps around the outlet conduit 150 can also result in a larger primary inlet chamber 170 than if the baffle 166 extended between sidewalls 118. The larger inlet chamber 170 can provide a larger volume for the effluent to be retained and the wastewater to separate from the FOG before entering the outlet chamber 174. Thus, a wrapped baffle 166 can result in lower velocities and higher retention time for the wastewater in the inlet chamber 170. The interceptor 110 may also include a deflector 162 at the bottom wall 114 that surrounds the outlet intake 158. In some embodiments, the deflector 162 and baffle 166 may be connected and installed together to help properly align the deflector 162 and baffle 166 relative to each other and to the outlet conduit 150.

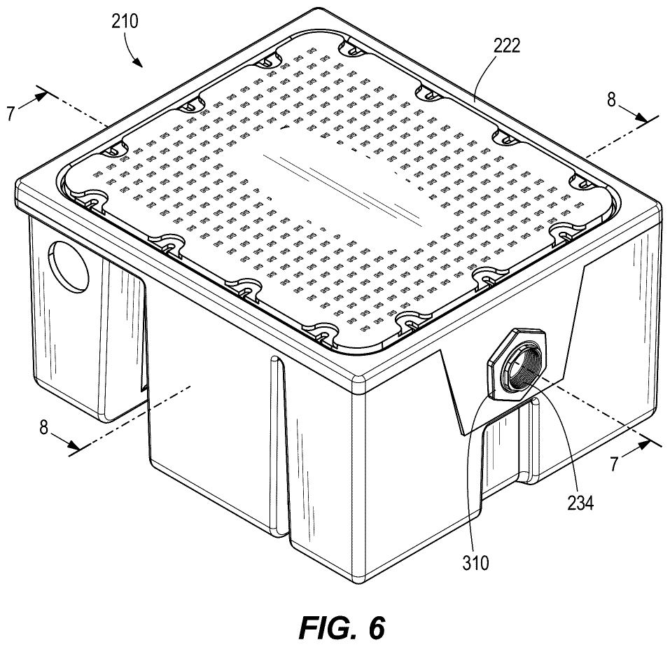

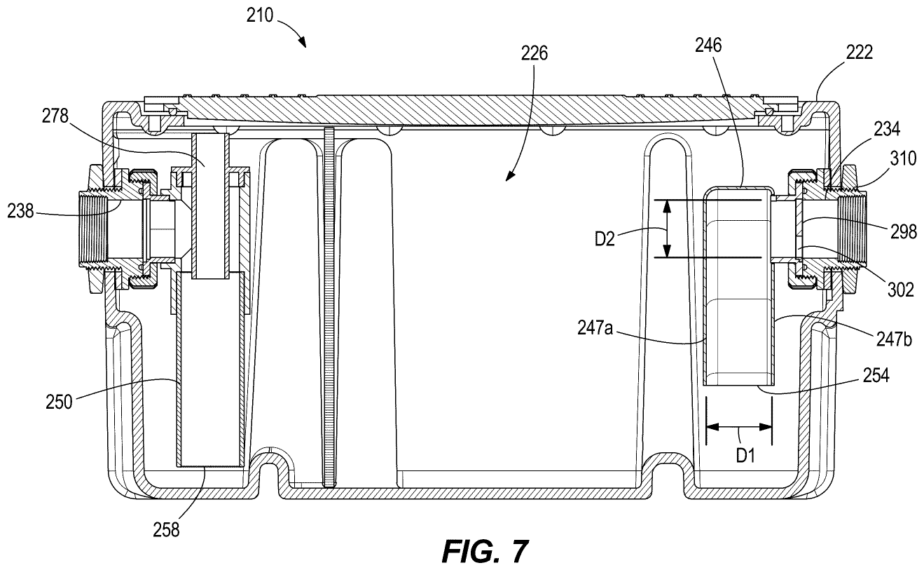

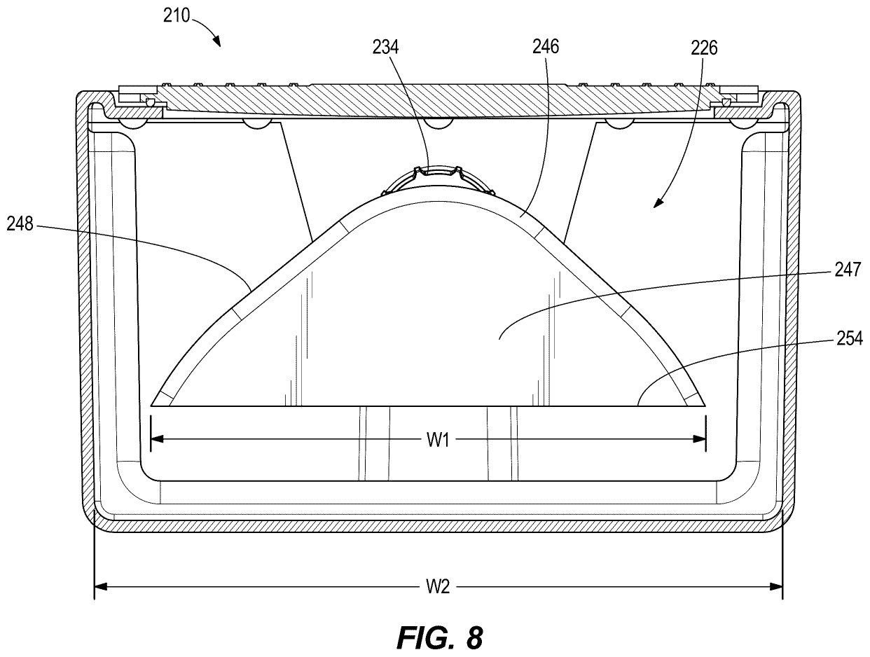

FIGS. 6-8 illustrate another embodiment of an interceptor 210. Interceptor 210 may include an inlet conduit or diffuser 246 with a large inlet discharge 254 to reduce the speed of the effluent as it enters the main chamber 226 of the interceptor 210. As shown in FIG. 8, the diffuser 246 may have a generally triangular or trapezoidal shape. With reference to FIG. 7, effluent may flow through the inlet 234 substantially horizontally into the diffuser 246 where it is obstructed by an end panel or wall 247 of the diffuser 246 and is biased or forced to flow outwards and downwards. The flow that is biased outwards is then biased by the downwardly angled panels or sidewalls 248 of the diffuser 246 to flow downward, and the overall effect is that the incoming effluent is dispersed across the large cross sectional inlet discharge 254 before entering the chamber 226, thereby reducing the entering effluent velocity. In some embodiments, the diffuser 246 can include guides to further promote even dispersion of the effluent flow through the inlet discharge 254. In some embodiments, the diffuser 246 may be vented to the air residing at the upper region of the chamber 226 near the top wall 222.

The diffuser 246 and inlet discharge 254 may be sized relative to the size of the inlet 234 and/or the size of the chamber 226. The diffuser 246 may have a depth D1 that is approximately equal to or slightly greater than the diameter D2 of the inlet 234. For example, the depth D1 of the diffuser 246 may be approximately 2.3 inches, and the diameter D2 of the inlet 234 may be approximately 2 inches. As shown, the depth D1 of the diffuser 246 may be essentially uniform throughout the vertical height of the diffuser 246. In some embodiments, the depth of the diffuser 246 may vary, such as having an increasing depth moving from the inlet 234 towards the inlet discharge 254. In such embodiments, the end wall 247a nearer the outlet 238 may remain substantially vertical or only slightly angled to ensure the effluent is forced downwards and is not given a direct flow path towards the outlet 238. The end wall 247b nearer the inlet 234 may be angled towards the inlet 234 to provide an increasing depth D1 of the diffuser 246.

As shown in FIG. 7, the inlet discharge 254 may have a width W1 that extends a substantial portion (e.g., 60-90%) of the width W2 between sidewalls 218 of the chamber 226. For example, the width W1 of the inlet discharge 254 may be approximately 16.5 inches and the width W2 between sidewalls 218 may be approximately 22 inches. The width W1 of the inlet discharge 254 may also be configured relative to the diameter D2 of the inlet 234. For example, the width W1 may be approximately four times to twelve times larger than the diameter D2. In some embodiments, the width W1 may be approximately eight times larger than the diameter D2. The cross-sectional area of the inlet discharge 254 may be at least four times larger than the cross-sectional area of the inlet 234 (resulting in an approximately average four times reduction in the average velocity of the incoming effluent from the inlet wastewater piping to the inlet discharge 254 into the chamber 226). In some embodiments, the cross-sectional area of the inlet discharge 254 may be at least two times larger than the cross-sectional area of the inlet 234. In some embodiments, the cross-sectional area of the inlet discharge 254 may be at least six times larger than the cross-sectional area of the inlet 234. In some embodiments, the cross-sectional area of the inlet discharge 254 may be at least twelve times larger than the cross-sectional area of the inlet 234.

As shown in FIG. 8, the sidewalls 248 of the diffuser 246 may be downwardly angled relative to horizontal. For example, the sidewalls 248 may be angled downwardly between approximately 30 degrees and approximately 70 degrees relative to a horizontal plane. In some embodiments, the downward angle of the sidewall 248 may increase moving downward from the area of the inlet 234 to the inlet discharge 254. For example, the sidewall 248 nearer the midline of the diffuser 246 may be angled at approximately 40° and the sidewall 248 nearer the inlet discharge 254 may be angled at approximately 60° relative to a horizontal plane. The shallower downward angle near the inlet 234 can help ensure the effluent is dispersed throughout the full width of the diffuser 246, and the steeper downward angle near the inlet discharge 254 can give the effluent a more downward flow path or as it enters the chamber 226 to then promote separation of the entrained FOG.

As shown in FIG. 7, the interceptor 210 may operate without a baffle or partition separating the chamber 226 into sub-chambers. This can provide maximum liquid volume retention time in a single undisturbed chamber 226 for the low velocity effluent to separate into wastewater and FOG. The interceptor 210 may include an air relief bypass 278 in the outlet conduit 250 to increase the liquid level and further increase the effective liquid volume of the chamber 226 as disclosed above.

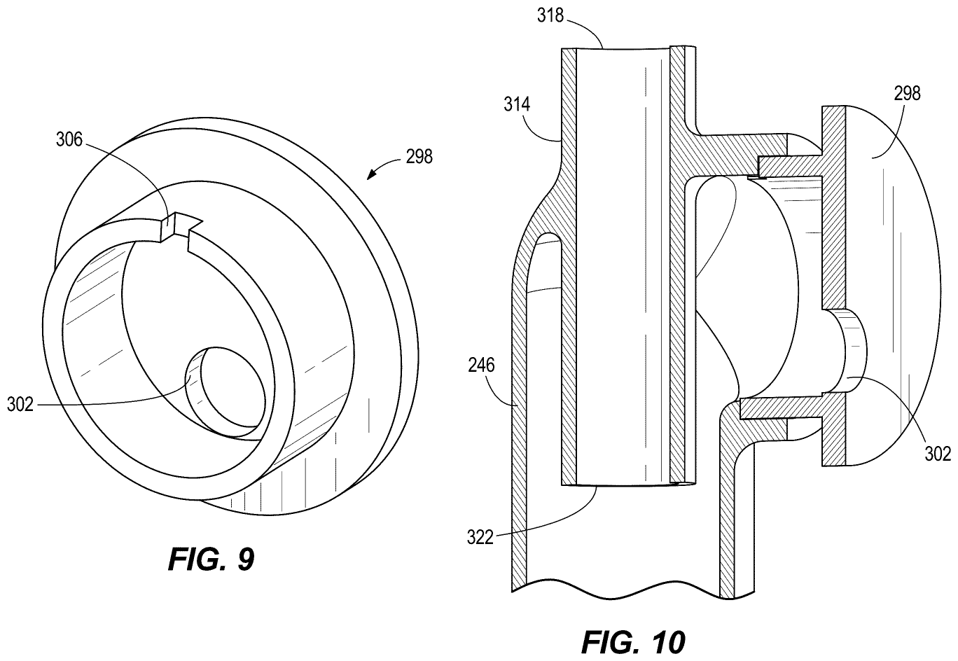

As shown in FIGS. 7, 9, and 10, the interceptor 210 may include a flow control orifice fitting 298 to control the incoming flow of effluent at the inlet 234. The flow control orifice fitting 298 may include an aperture or orifice 302 sized and positioned to help restrict or control entering effluent flow as desired regardless of upstream piping size, head pressure, and flow rates. The orifice 302 may be offset from center of the flow control orifice fitting 298 and may be ideally positioned such that the orifice 302 is at a lower end of the inlet 234. As shown in FIG. 9, the flow control orifice fitting 298 may include a key or slot 306 that aligns with a corresponding protrusion or feature of the inlet conduit or diffuser 246 to ensure the orifice 302 is properly aligned and positioned as designed. In some embodiments, the inlet conduit or diffuser 246 may include the key or slot and the flow control orifice fitting 298 may include a corresponding protrusion or feature to align with the key. As shown in FIG. 7, the interceptor 210 may include a bulkhead union or fitting 310 or other rotational fitting for securing the inlet 234 to the inlet port. Rotation of the bulkhead fitting 310 could cause the orifice 302 to be misaligned relative to the inlet conduit or diffuser 246 if not for the key 306. The key 306 allows for infinite rotational adjustment of the bulkhead fitting 310 while maintaining proper orifice 302 to inlet conduit or diffuser 246 alignment without having to visibly see or check the orifice 302.

The interceptor 210 may include an air or gas bubbler that introduces air or gas into the effluent in the chamber 226. The air bubbles are highly buoyant and can carry effluent upwards where the FOG is more likely to remain while the denser water can separate out to sink downwards. Additionally, FOG particles or droplets are more likely to adhere to air bubbles, so the air bubbles carry a greater proportion of FOG than wastewater upwards, which accelerates the separation further. In some embodiments, the air bubbler may inject air bubbles into the inlet 234 so that FOG can adhere to the air bubbles which then buoyantly rise in the chamber 226 once the air bubbles have been carried into the chamber 226. This configuration can ensure the entering effluent is sufficiently aerated by the air bubbles without having to have an air bubbler that spans a significant portion of the FOG interceptor 210. In some embodiments, an air bubbler may have multiple discharge ports or an evenly dispersed discharge across the width of the interceptor 210. The discharge ports may be positioned proximate the inlet discharge 254 in the chamber 226 so that the air bubbles can immediately carry upwards and separate a high proportion of entering FOG from the wastewater. In some embodiments, the discharge ports may be positioned proximate the outlet intake 258 so that air bubbles can prevent any FOG that has not separated from the wastewater from entering the outlet intake 258.

The air bubbler may have an air intake inside the chamber 226 near the top wall 222 so that air is recirculated by the air bubbler and no new air is introduced from the external atmosphere into the chamber 226 by the air bubbler. In some embodiments, the bubbler may be hydro-mechanically and pressure powered such that air is forced through the air intake to create air bubbles when effluent flows into the inlet 234. For example, as illustrated in FIG. 10, an air bubbler 314 may be located in the inlet conduit or diffuser 246 and may have an air intake 318 extending through the inlet conduit or diffuser 246 such that an air intake 318 of the air bubbler 314 is positioned inside the chamber 226 near the top wall 222. The air outlet or air discharge 322 may be positioned in the inlet conduit 246 or otherwise near the inlet 234 to aerate inflowing effluent. Because the FOG interceptor 210 is sealed to atmosphere, inflowing effluent into the chamber 226 can force air in the upper region of the chamber 226 to flow through the air bubbler 314 and into the effluent near the inlet 234 (i.e., an air “burping” effect). The air discharge 322 may be positioned in an upper end of the inlet conduit or diffuser 246 but below a lowermost portion of the inlet 234. The velocity of the effluent in the upper end of the inlet conduit or diffuser 246 is higher than the velocity in the chamber 226, which creates a low-pressure region in the upper end of the inlet conduit or diffuser 246 relative to the chamber 226. This pressure differential may further vacuum or draw air from the upper region of the chamber 226 into the upper end of the inlet conduit or diffuser 246 to aerate the effluent. In some embodiments, air bubbles may be created by an electric pump system or the like. The pump system may be triggered to turn on only when effluent flow is detected near the inlet 234 or at an upstream portion of the wastewater system.

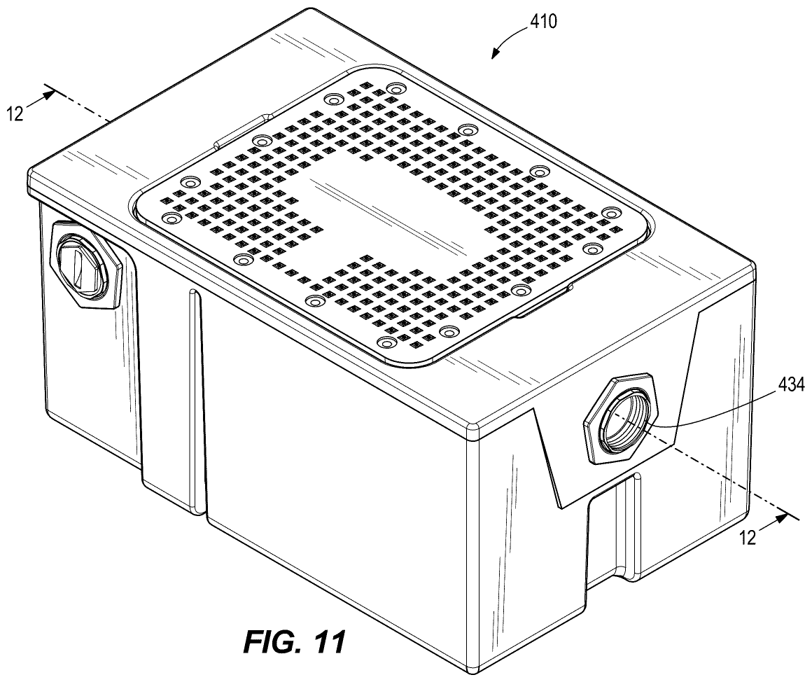

FIGS. 11-13 illustrate another embodiment of an interceptor 410. Features that are similar to features of the interceptor 210 shown in FIGS. 6-8 are identified with similar reference numbers, plus 200. Some similarities and differences between the interceptor 410 and interceptor 210 are described herein.

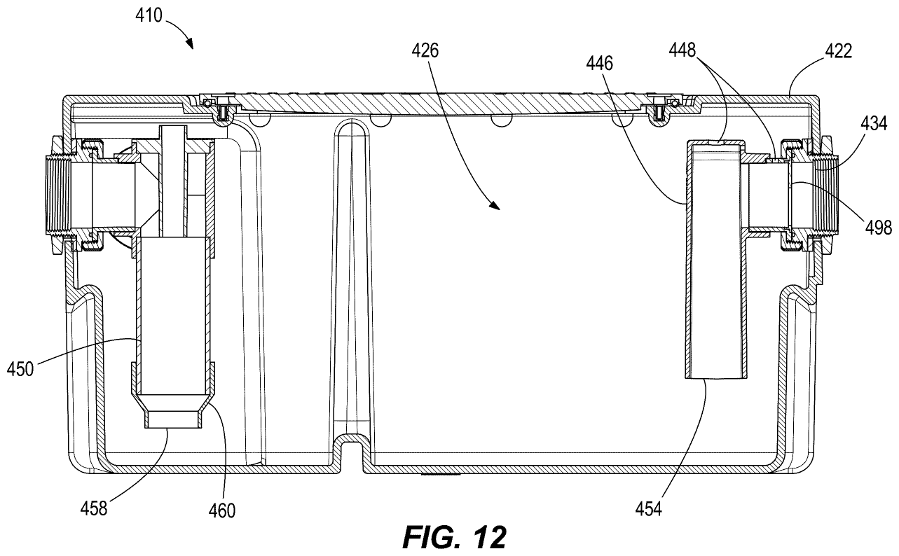

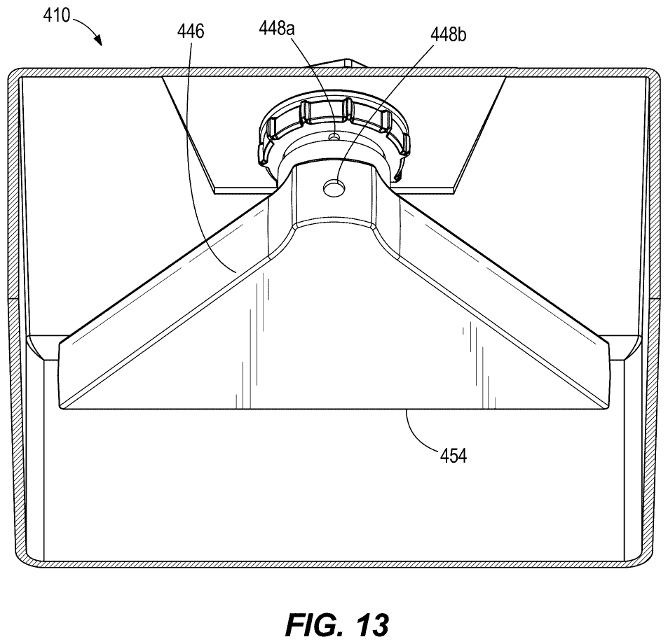

Interceptor 410 may include an inlet conduit or diffuser 446 with a large inlet discharge 454 to reduce the speed of the effluent as it enters the main chamber 426 of the interceptor 410. As shown in FIG. 13, the diffuser 446 may have a generally triangular or trapezoidal shape. The overall effect of the shape of the diffuser 446 is that incoming effluent is dispersed across the large cross sectional inlet discharge 454 before entering the chamber 426, thereby reducing the entering effluent velocity. As shown in FIG. 13, the diffuser 446 may include one or more vents or openings 448 that are in fluid communication with the air at the upper region of the chamber 426 near the top wall 422. The openings 448 can vent or relieve water pressure of effluent as it enters the diffuser 446 and allow air into the diffuser 446 to reduce velocity of the effluent. In some embodiments, as shown, a first opening 448a may be located on an upper side of the stub, pipe, or conduit that couples the main triangular or trapezoidal body of the diffuser 446 to the inlet opening 434 of the interceptor 410, and a second opening 448b may be located on an upper side of the main triangular or trapezoidal body of the diffuser 446. As shown in FIG. 12, the upper portion of the main triangular or trapezoidal body of the diffuser 446 may be positioned above an upper end of the inlet opening 434, which can reduce the likelihood that effluent flows out of the second opening 448b (and increases the likelihood of air flowing in). The first opening 448a and second opening 448b may have different primary functions and may be separated by an orifice fitting 498. The first opening 448a may primarily provide a pressure reducing vent or pressure relief outlet for incoming effluent by discharging high pressure water/effluent out of the first opening 448a to reduce the velocity of the effluent. The second opening 448b may primarily provide an air inlet for air from the upper region of the chamber 426 to enter the diffuser 446 and mix as small air bubbes with the incoming effluent. The mixing of air can have a dampening or shock absorption effect that can further reduce the velocity and turbulence of the effluent. Additionally, FOG can better adhere to the air bubbles, which will buoyantly rise upwards once discharged out of the diffuser 446. As shown, the first opening 448a may be smaller than the second opening 448b.

The interceptor 410 may include a reducer 460 at the outlet intake 458 of the outlet conduit 450. That is, the outlet intake 458 may have a reduced cross-sectional area compared to the main body of the outlet conduit 450. Reducing the area of the outlet intake 458 can reduce the flow of water through the outlet conduit. This can temporarily raise the effective liquid level in the chamber 426 during periods of operation. The incoming effluent, which is not restricted by a reduced inlet area, enters the chamber at a higher flow rate than the flow rate of water exiting through the reduced outlet intake 458. The increased effective liquid level in the chamber 426 can increase the air pressure (and consequently the air entrainment and bubbling effect at the inlet side) inside the chamber 426 because the volume of space for the air in the sealed chamber 426 is reduced. Raising the effective liquid level also increases the volume of effluent and water inside the chamber 426, such that for the same flow rate, the velocity and turbulence of the effluent and water is reduced. Additionally, raising the effective liquid level can increase the distance of the floating FOG pack from the outlet intake 458, which reduces the likelihood that any floating FOG could be carried into the outlet intake 458 by flowing water.

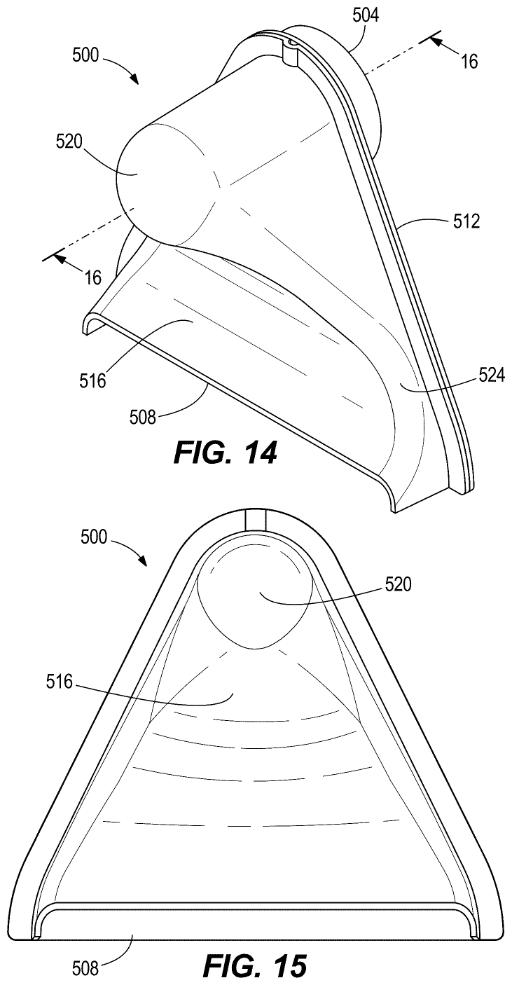

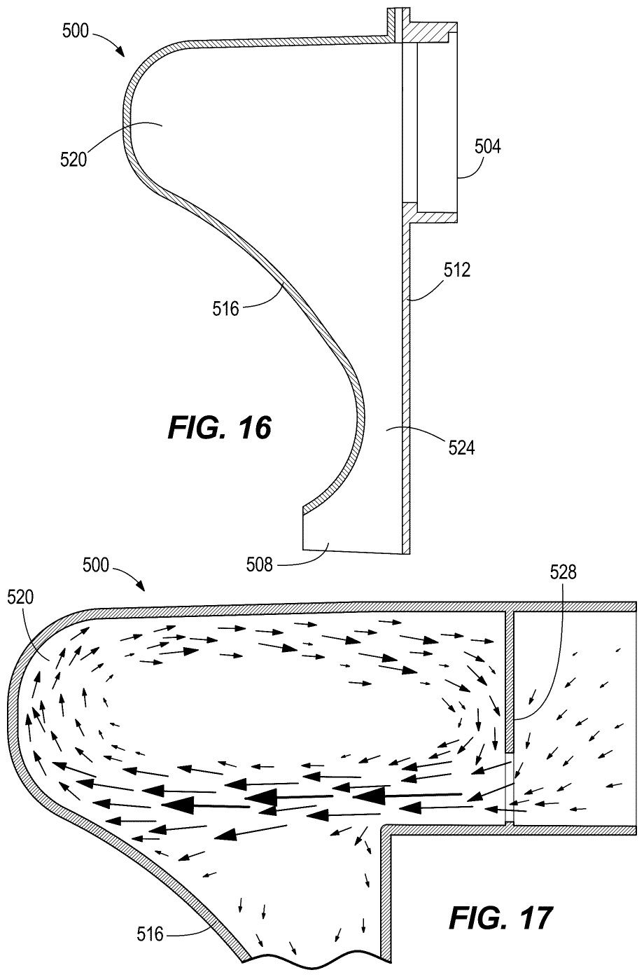

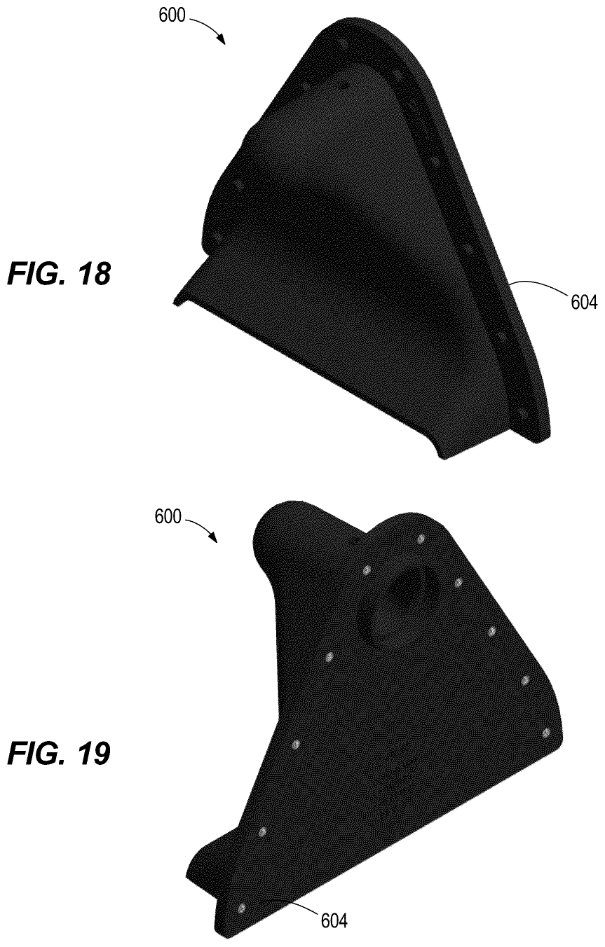

FIGS. 14-16 illustrate another embodiment of an inlet diffuser 500 for use with a FOG interceptor. As shown in FIG. 15, the diffuser 500 may have a generally triangular or trapezoidal shape such that the width of the diffuser increases from an upper end proximate the inlet opening 504 to a lower end proximate the diffuser discharge 508 such that the width at the diffuser discharge 508 is larger than at the inlet opening 504. As shown in FIG. 16, the diffuser 500 may include a generally upright planar or vertical end wall 512 at an upstream side of the diffuser 500 (i.e., proximate the inlet opening 504). In some embodiments, the vertical end wall 512 may be mounted to a sidewall of the FOG interceptor (see FIGS. 18 and 19 illustrating a diffuser 600 with a mounting plate 604, which may include mounting holes for fastening to the sidewall of a FOG interceptor). The diffuser 500 may include a curved end wall 516 (or angled end wall) at a downstream side of the diffuser 500 (i.e., distal the inlet opening 504). The curved end wall 516 and diffuser 500 may include a bulbous head or expansion area 520 proximate the inlet opening 504. The curved end wall 516 may angle or extend towards the vertical end wall 512 to provide a “pinched” or contracted or reduced depth portion 524 between the expansion area and the diffuser discharge 508. The curved end wall 516 may angle or extend back away from the vertical wall 512 such that the diffuser discharge 508 has an increased depth or cross-sectional area compared to the reduced depth portion 524. For example, the ratio of the cross-sectional area of the diffuser discharge to the cross-sectional area of the reduced depth portion may be at least 2.0. In some embodiments, the ratio may be at least 3.0. In some embodiments, the ratio may be at least 4.5. In some embodiments, the ratio may be at least 6.0.

The bulbous head or expansion area 520, which may be generally in-line with the inlet opening 504, can provide a large volume for incoming effluent to rush in without creating turbulence in a chamber of the interceptor. The curved end wall 516 can redirect the incoming effluent towards the reduced depth portion 524, which can help ensure that effluent flow is distributed more evenly across the width of the diffuser 500 as opposed to primarily focusing in a central region in-line with the inlet opening 504. Due to the expanding width of the diffuser 500, the reduced depth portion 524 can still have an equal or larger cross-sectional area or flow area than the inlet opening 504 such that overall fluid velocity is reduced or maintained. For example, in some embodiments, the ratio of the cross-sectional area of the reduced depth portion 524 to the cross-sectional area of the inlet opening 504 may be at least 1.1. In some embodiments, the ratio may be at least 1.5. In some embodiments, the reduced depth portion 524 may have a cross-sectional area or flow area that is smaller than the inlet opening 504. For example, in some embodiments, the ratio of the cross-sectional area of the reduced depth portion 524 to the cross-sectional area of the inlet opening 504 may be at 0.9 or less.

The redirection of the incoming effluent can reduce the fluid pressure and turbulence of the effluent. The expanded area of the diffuser discharge 508 can further reduce the velocity and turbulence of the effluent flow as it enters the chamber of the interceptor. As illustrated by the computational fluid dynamics (CFD) diagram of effluent flowing through the diffuser 500 in FIG. 17, high velocity effluent may enter the diffuser 500 through an orifice in an orifice fitting 528. The orifice of the orifice fitting 528 may be positioned such that the high velocity effluent enters the diffuser at a lower portion of the expansion area 520, which in turn impacts effluent that is flowing down from the top of the expansion area 520 and disperses low velocity flow into the trapezoidal part of the diffuser 500 (i.e., towards the reduced depth portion 524) where it can then further distribute evenly into the main chamber of the interceptor through the diffuser discharge 508.

It will be understood that certain features and sub combinations are of utility and may be employed without reference to other features and sub combinations. Features described and illustrated with respect to certain embodiments may also be implemented in other embodiments. This is contemplated by and is within the scope of the claims. Since other possible embodiments of the disclosure may be made without departing from the scope thereof, it is understood that examples herein described or shown in the accompanying drawings are to be interpreted as illustrative and are not intended to limit the concepts and principles of the present disclosure.

Many changes, modifications, variations and other uses and applications of the illustrated examples will become apparent to those skilled in the art after considering the specification and the accompanying drawings. Such changes, modifications, variations and other uses and applications are deemed to be covered by the disclosure.

1. A FOG interceptor for separating FOG from wastewater, the FOG interceptor comprising:
a chamber having at least one outer wall extending upward from a bottom wall;
an inlet in the at least one outer wall at a first end of the chamber, the inlet having a first cross-sectional area;
an outlet in the at least one outer wall at a second end of the chamber;
an inlet diffuser fluidly coupled to the inlet, the inlet diffuser having a discharge opening in fluid communication with the chamber, the discharge opening having a second cross-sectional area that is at least 2 times a size of the first cross-sectional area of the inlet; and
an outlet conduit fluidly coupled to the outlet, the outlet conduit having an intake opening located in a lower region of the chamber.

2. The FOG interceptor of claim 1, wherein the inlet diffuser has a width that increases from a top of the inlet diffuser adjacent the inlet to a bottom of the inlet diffuser.

3. The FOG interceptor of claim 1, wherein the inlet diffuser has a sidewall that is oriented at a first downward angle relative to a horizontal plane proximate a top of the inlet diffuser, wherein the sidewall of the inlet diffuser is oriented at a second downward angle relative to the horizontal plane proximate a bottom of the inlet diffuser, and wherein the first downward angle is less than the second downward angle.

4. The FOG interceptor of claim 1, wherein the inlet includes a flow control orifice for regulating flow of wastewater into the chamber.

5. The FOG interceptor of claim 1, wherein the inlet includes a flow control orifice fitting having a flow control orifice, wherein the flow control orifice fitting includes one of a key or a protrusion corresponding to the key, and wherein the inlet diffuser includes the other of the key or the protrusion corresponding to the key for aligning orientation of the flow control orifice relative to an orientation of the inlet diffuser.

6. The FOG interceptor of claim 1, further comprising a baffle that separates the chamber into a first sub-chamber and a second sub-chamber, wherein a gap is provided between a bottom edge of the baffle and the bottom wall of the chamber such that wastewater can flow from the first sub-chamber to the second sub-chamber through the gap.

7. The FOG interceptor of claim 6, wherein the baffle wraps around a vertical portion of the outlet conduit.

8. The FOG interceptor of claim 7, further comprising a deflector extending upwards from the bottom wall, the deflector wrapping around the intake opening of the outlet conduit.

9. The FOG interceptor of claim 1, further comprising a deflector extending across the bottom wall of the chamber, the deflector positioned between the first end and the second end of the chamber.

10. The FOG interceptor of claim 1, further comprising an air bubbling device that injects air bubbles into the wastewater at the inlet.

11. The FOG interceptor of claim 1, wherein the inlet diffuser has a vent in fluid communication with an upper region of the chamber.

12. The FOG interceptor of claim 1, wherein the inlet diffuser includes a main body and a coupling portion, the coupling portion coupling the main body to the inlet, wherein a first vent opening is disposed on the coupling portion, and wherein a second vent opening is disposed on the main body of the inlet diffuser, the second vent opening positioned above the first vent opening.

13. The FOG interceptor of claim 1, wherein the intake opening of the outlet conduit has a smaller cross-sectional area than the outlet.

14. The FOG interceptor of claim 1, wherein a reducer is coupled to the outlet conduit to form the intake opening of the outlet conduit, the intake opening having a smaller cross-sectional area than a main body portion of the outlet conduit.

15. A FOG interceptor for separating FOG from wastewater, the FOG interceptor comprising:
a chamber having at least one outer wall extending upward from a bottom wall;
an inlet in the at least one outer wall at a first end of the chamber;
an outlet in the at least one outer wall at a second end of the chamber;
an inlet conduit fluidly coupled to the inlet, the inlet conduit having a discharge opening located in a lower region of the chamber;
an outlet conduit fluidly coupled to the outlet, the outlet conduit having an intake opening located in the lower region of the chamber; and
an air relief bypass having a first aperture positioned proximate an upper end of the chamber and a second aperture positioned within the outlet conduit and below the outlet.

16. The FOG interceptor of claim 15, wherein the air relief bypass is configured to simulate a vacuum pressure in the outlet conduit to maintain a wastewater level in the chamber above a lowermost portion of the outlet.

17. The FOG interceptor of claim 15, wherein the air relief bypass is a bypass conduit extending through an upper end of the outlet conduit.

18. The FOG interceptor of claim 15, further comprising a baffle that separates the chamber into a first sub-chamber and a second sub-chamber, wherein a gap is provided between a bottom edge of the baffle and the bottom wall of the chamber such that wastewater can flow from the first sub-chamber to the second sub-chamber through the gap.

19. The FOG interceptor of claim 18, wherein the baffle wraps around a vertical portion of the outlet conduit.

20. The FOG interceptor of claim 19, further comprising a deflector extending upwards from the bottom wall, the deflector wrapping around the intake opening of the outlet conduit.

21. A FOG interceptor for separating FOG from wastewater, the FOG interceptor comprising:
a chamber having at least one outer wall extending upward from a bottom wall;
an inlet in the at least one outer wall at a first end of the chamber;
an outlet in the at least one outer wall at a second end of the chamber;
an inlet conduit fluidly coupled to the inlet, the inlet conduit having a discharge opening located in a lower region of the chamber;
an outlet conduit fluidly coupled to the outlet, the outlet conduit having an intake opening located in the lower region of the chamber; and
a flow control orifice fitting having a flow control orifice;
wherein the flow control orifice fitting includes one of a key or a protrusion corresponding to the key, and wherein the inlet conduit includes the other of the key or the protrusion corresponding to the key for aligning orientation of the flow control orifice relative to an orientation of the inlet conduit.

22.-26. (canceled)
